(19) United States
(12) Patent Application Publication
(10) Pub. No.: US 2024/0261801 A1
(43) Pub. Date: Aug. 8, 2024

(54) Plate Type Rotational Separator

(71) Applicant: Biorganics UFT B.V., VALTHERMOND (NL)

(72) Inventors: Andreas Tiemann, Tweede Exloermond (NL); Hendrik Arie Boele, Hoogstraten (BE)

(21) Appl. No.: 18/578,984

(22) PCT Filed: Jul. 13, 2022
(86) PCT No.: PCT/NL2022/050409

§ 371 Date: Jan. 12, 2024

(30) Foreign Application Priority Data
Jul. 14, 2021 (NL) 2028726

(51) Int. Cl. B04B 1/06; B04B 7/12

(52) U.S. Cl. CPC B04B 1/06; B04B 7/12

(57) ABSTRACT

The present invention related to plate type rotational separator, comprising: a carrier (110) that is rotatable around an axial axis thereof; and a plurality of plates (121) extending in an axial direction of, and in a radial outward direction relative to, the axial axis of the carrier, wherein each of the plurality of plates (121) comprises at least one support (122) extending transverse to a surface of the plate and in a circumferential direction relative to the axial axis of the carrier, to thereby provide circumferential support for said plate when the support of said plate is supported on an adjacent plate of the plurality of plates during rotation of the carrier.

The present invention relates to a plate type rotational separator for reclaiming or separating one or more components from a fluid, in particular a liquid. Such components, for example, may comprise solid matter such as contaminants, debris or algae, as well as liquid matter including oils or other liquids having a density different from the fluid from which they are to be reclaimed.

Plate type rotational separators of the above type are utilised in a wide variety of applications and in many different industries. To remove a component from a liquid, such separators exploit the centrifugal force acting upon any component particles suspended in the fluid from which they are to be separated. After separation, the fluid and the one or more components separated therefrom may be expelled separately from the plate type rotational separator.

Known plate type rotational separators of the here above described type comprise a number of considerable disadvantages, which at the present time limit their usage and practical utility.

First, known designs for plate type rotational separators are constrained with respect to the rotation speed at which they may operate. Generally, a higher rotation speed results in a more efficient separation process, which is advantageous when a high separation throughput is required or when the component to be separated comprises a density only slightly different from the fluid in which it is suspended. However, higher rotation speeds induce an increased amount of mechanical stress on the construction of the plate type rotational separator, which may lead to the separator being damaged or otherwise inhibits its performance.

A second disadvantage of known designs for plate type rotational separators relates to their scalability. It has been found that constructing known plate rotational separators at a larger scale with increased physical dimensions, for example so that a larger amount of fluid may be accommodated and processed, results in a loss of structural integrity during operation of the separator, in particular at higher rotation speeds. This likewise results in the separator being damaged or otherwise having decreased performance during operation.

A third disadvantage of known plate type rotational separators relates to the requirements imposed on the materials of in particular any moving components of such separators. Due to the considerable rotation speeds at which such separators may operate, and the resulting correspondingly large forces acting upon in particular the blades or plates of such separators, these plates must comprise a material capable of withstanding these forces. In practice, a rigid material is applied, such as metal, in particular (stainless) steel. Steel and comparable materials comprise a relatively high density and thus increase the overall weight of the plate type rotational separator. Moreover, the manufacturing of any components from steel or other metals is relatively complex in comparison to manufacturing such components from for example plastics, which may be manufactured by means of injection molding. This increased degree of manufacturing complexity moreover contributes to increased manufacturing costs in addition to the base costs of the used materials.

Reference is made here to US 660 360 A, which discloses a “centrifugal liquid separator” that exhibits the disadvantages described hereabove. The documents US 661 943 A, EP 2014 346 A1 and DE 178 650 C may bear at least some relevance to the present invention.

The objective of the present invention is to provide a plate type rotational separator of the type described here above, with which one or more of the disadvantages of known plate type rotational separators is obviated or abated.

This objective is achieved with a plate type rotational separator, comprising a carrier that is rotatable around an axial axis thereof; and a plurality of plates extending in an axial direction of, and in a radial outward direction relative to, the axial axis of the carrier, wherein each of the plurality of plates comprises at least one support extending transverse to a surface of the plate and in a circumferential direction relative to the axial axis of the carrier, to thereby provide circumferential support for said plate when the support of said plate is supported on an adjacent plate of the plurality of plates during rotation of the carrier. The plurality of plates comprises at least plates of a first type and plates of a second type, wherein the plates of the first type have their respective at least one support arranged at a first radial distance relative to the carrier and the plates of the second type have their respective at least one support arranged at a second radial distance relative to the carrier, said second radial distance being different from the first radial distance.

The here above described plate type rotational separator advantageously comprises an improved distribution and/or absorption of internal forces and torques during operation, which result from the considerable centrifugal forces to which the separator is subjected. Consequently, the proposed plate type rotational separator may be operated at a rotation speed higher than rotation speeds at which prior-art separators may be operated. Moreover, due to the improved distribution and absorption of the generated forces in particular the plates of the separator may be manufactured from a material which is cheaper or easier to process than is the case with certain prior-art separators; and the physical dimensions of the separator according to the present invention may be greater than those of prior-art separators, which results in an improved separation rate or operational capacity.

In a further preferred embodiment of the separator according to the present invention, the plates of the first type and the plates of the second type are arranged alternately around a perimeter of the rotatable carrier.

In a further preferred embodiment of the separator according to the present invention, the plurality of plates comprises a plurality of plate pairs, each plate pair comprising one plate of the first type and one plate of the second type.

In a further preferred embodiment of the separator according to the present invention, the plate of the first type and the plate of the second type of each plate pair are connected to the rotatable carrier through a common coupler.

In a further preferred embodiment of the separator according to the present invention, the supports of the plates of the first type are concentrically arranged around the central axis of the carrier.

In a further preferred embodiment of the separator according to the present invention, the supports of the plates of the second type are concentrically arranged around the central axis of the carrier.

In a further preferred embodiment of the separator according to the present invention, the concentric arrangement of the supports of the plates of the first type comprises a radius which is different from a radius comprised by the concentric arrangement of the supports of the plates of the second type.

In a further preferred embodiment of the separator according to the present invention, the at least one support of the plate of the first type and the at least one support of the plate of the second type are arranged to be approximately lined up one behind the other in at least part of the circumferential direction relative to the axial axis of the carrier.

In a further preferred embodiment of the separator according to the present invention, the supports of the plates of the first type and the supports of the plates of the second type are disposed one behind the other to form at least one array of supports non-concentric with the rotatable carrier.

In a further preferred embodiment of the separator according to the present invention, the at least one least one array of supports comprises a spiral-like shape non-concentric with the axial axis of the carrier.

In a further preferred embodiment of the separator according to the present invention, the plates are curved.

In a further preferred embodiment of the separator according to the present invention, the surface of each plate at which its respective at least one support is disposed is a concave surface. In other words, the at least one support is preferably arranged at a concave side of the curved plate. This support will then abut, i.e. support, against a convex side of an adjacent curved plate.

In a further preferred embodiment of the separator according to the present invention, the plates comprise a material from group comprising polymers, carbon fiber and glass fiber.

In a further preferred embodiment of the separator according to the present invention, the plates are pivotally connected to the carrier to allow the plates to pivot relative to the carrier.

In a further preferred embodiment of the separator according to the present invention, the supports are disposed on their respective plates, approximately one behind the other in an at least partially circumferential direction relative to the axial axis of the carrier, to thereby form at least one array of supports non-concentric with the rotatable carrier and at least partially extending outward relative thereto.

At least some of the here above described preferred embodiments result in a separator that is improved yet further with respect to its maximum rotation speed during operation, the selection of materials from which in particular the plates may be constructed, and its scalability.

The aforementioned objective of the present invention is moreover achieved with a method for separating one of more components from a fluid, comprising usage of a plate type rotational separator in accordance with the present invention as disclosed in this document.

In addition, the aforementioned objective is achieved with a plate assembly installable in a plate type rotational separator, the plate assembly comprising a plurality of plates configured to extend in an axial direction of, and in a radial outward direction relative to, an axial axis of a carrier when installed in the plate type rotational separator, wherein each of the plurality of plates comprises at least one support extending transverse to a surface of the plate and in a circumferential direction relative to the axial axis of the carrier, to thereby provide circumferential support for said plate when the support of said plate is supported on an adjacent plate of the plurality of plates during rotation of the carrier. The plurality of plates comprises at least plates of a first type and plates of a second type, wherein the plates of the first type have their respective at least one support arranged at a first radial distance relative to the carrier and the plates of the second type have their respective at least one support arranged at a second radial distance relative to the carrier, said second radial distance being different from the first radial distance.

Here below the present invention will be elucidated with reference to the drawing, in which:

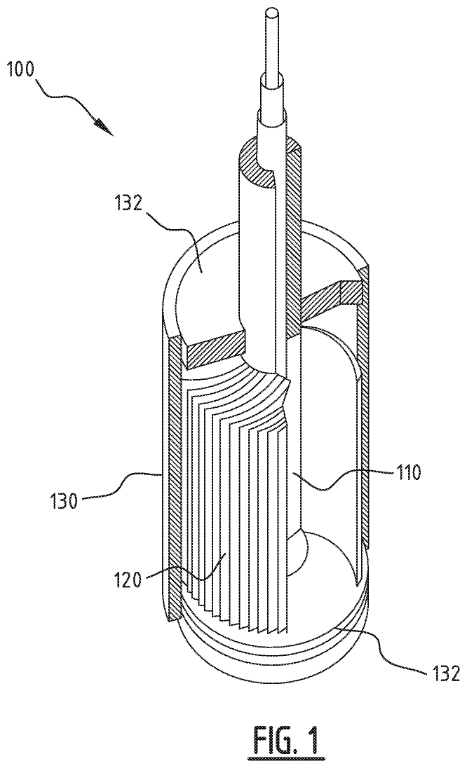

FIG. 1 depicts a cutaway view of a plate type rotational separator according to a general aspect regarding technological background of the present invention;

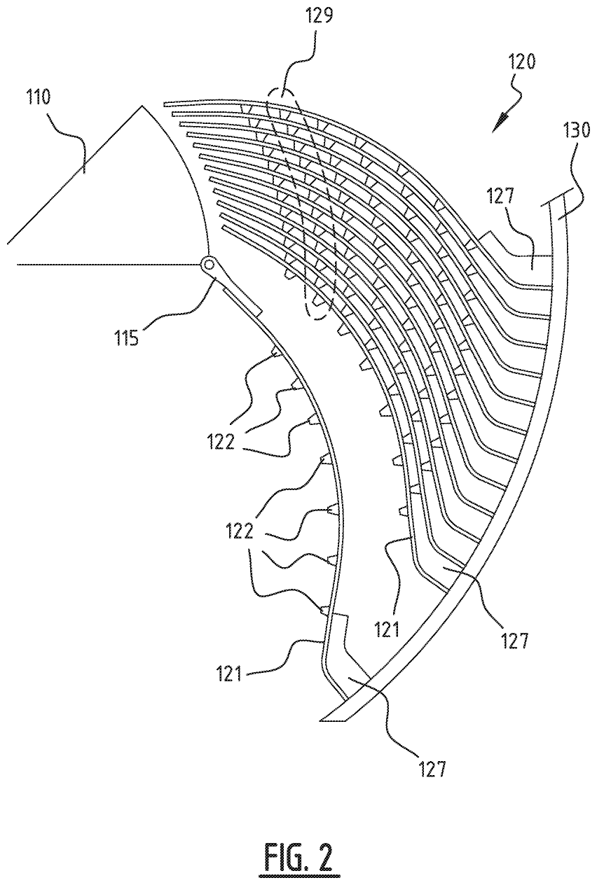

FIG. 2 depicts a cross-sectional top-down view of the separator of FIG. 1;

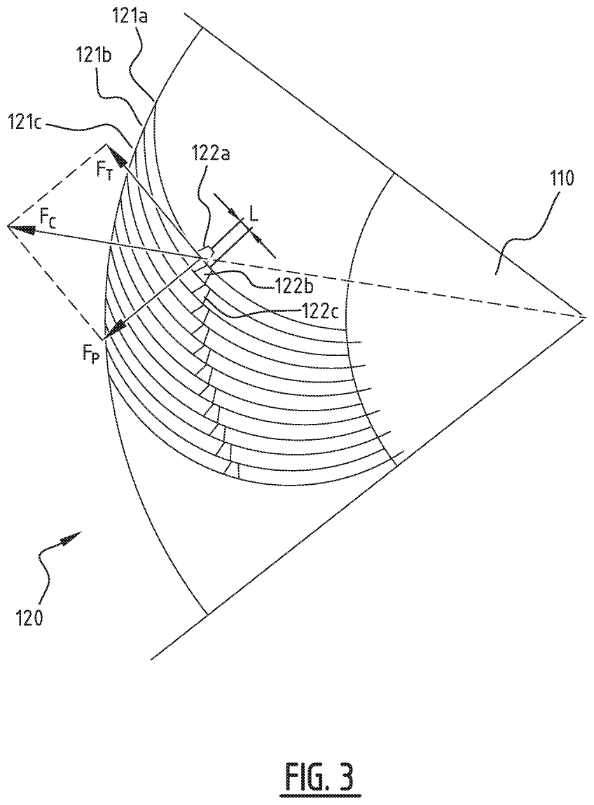

FIG. 3 depicts a cross-sectional top-down view of a simplified embodiment of the separator of FIG. 2, wherein at least some of internal forces during operation of the separator are indicated;

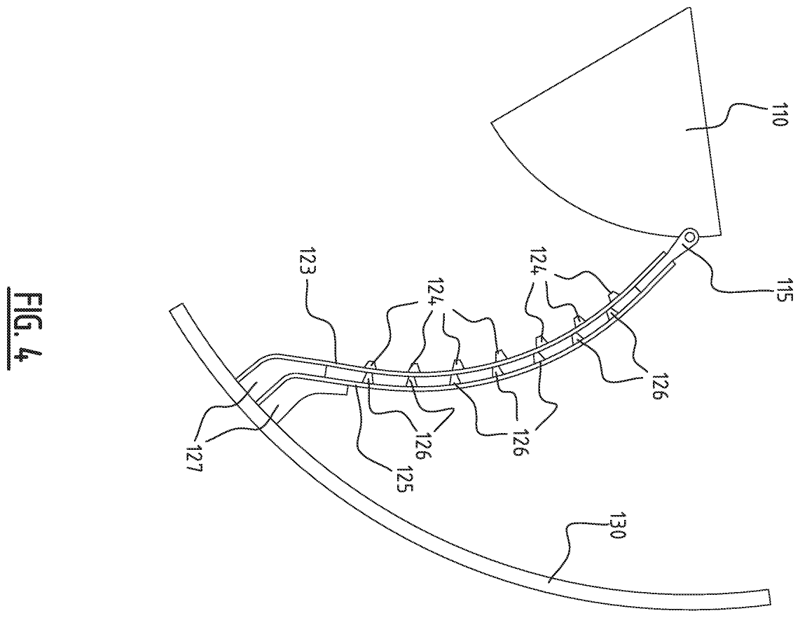

FIG. 4 depicts a preferred embodiment of plates of the plate type rotational separator according to the present invention in cross-sectional top-down view;

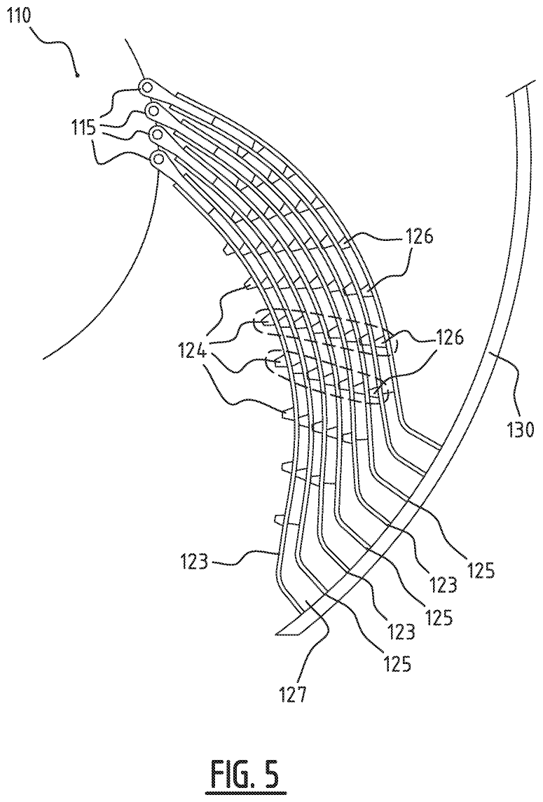

FIG. 5 depicts an expanded illustration of the separator as shown in FIG. 4; and

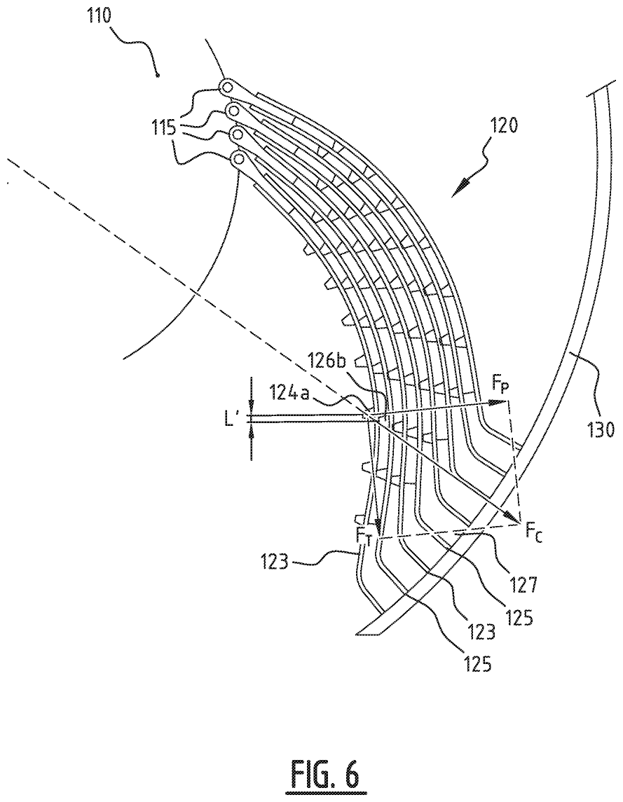

FIG. 6 depicts the embodiment of FIG. 5 wherein moreover at least some of internal forces during operation of the separator are indicated.

Referring now to FIG. 1, there is depicted a plate type rotational separator 100 in accordance with technological background of the present invention. The plate type rotational separator 100, which is henceforth referred to as the separator 100, comprises a housing with a side wall 130, a top cover 132 and a bottom cover 134, which collectively define an interior of the separator 100.

The plate type rotational separator 100 moreover comprises a carrier 110 centrally arranged within the interior of the rotational separator 100. The carrier 110 extends within the interior separator 100 from the bottom cover 134 towards the top cover 132 and is configured to be rotatable around its axial axis extending in the vertical direction.

A plurality of plates 120 is disposed around an outer perimeter of the carrier 110, with each one of the plates 120 preferably being arranged around the carrier 110 equidistantly. Each one of the plates 120 extends in a radially outward direction relative to the carrier 110, such that each plate is adjacent to, or abuts, an inner surface of the side wall 130. As is shown in the figure, each of the plurality of plates 120 moreover extends in a vertical direction along a substantial portion of the height of the carrier 110, which direction coincides with the axial direction of the carrier 110.

During operation of the separator 100, the carrier 110 and the plurality of plates connected thereto are actuated to rotate in a rotary direction. A (non-depicted) drive, such as a combustion engine or electric motor, may be present to rotate the carrier 110.

Fluid, in particular liquid, comprising one or more components to the separated therefrom is fed into the interior of the separator 100 and into intermediate spaces between each of the plurality of plates 120. A fluid inlet may be provided at or near a top of the interior of the separator 100 for this purpose, for example in the top cover 132.

As a result the rotation of the carrier 110 and the plurality of plates 120, fluid fed into the interior of separator 100 is brought into a circular motion and thus subjected to a centrifugal force acting on both the fluid and any particles of a component suspended in this fluid. Because particulars of the component comprise a density higher than the fluid from which they are to be separated, said particulars are forced in an outward radial direction relative to the axial axis of the carrier 110 under the influence of this centrifugal force. The fluid, which comprises a density lower than that of the particulars of the component, is less affected by the centrifugal force and consequently more substantially flows in a downward direction, thus leading to a separation of the at least one component from the fluid.

Separate outlets (not shown) may be provided for respectively the fluid and the at least one component separated therefrom, through which the fluid and the component may flow out of the interior of the separator 100.

In the embodiment of FIG. 1, each one of the plurality of plates 120 comprises a curved shape. Usage of curved plates is found to be advantageous as it results in an improved separation efficiency relative to flat plates, in particular for component particulars that enter the interior of the separator 100 near an outer radius of the plurality of plates 120. However, the present invention is not limited to curved plates. The advantages of the present invention may likewise be achieved with plates comprising a flat shape or a shape that otherwise deviates from the depicted embodiments.

The side wall 130 of the housing is preferably detachably connected to the rest of the separator 100, which is advantageous when the separator 100 is to be cleaned to remove any build-up of residue in the intermediate spaces between each of the plurality of plates 120. During a cleaning operation, the side wall 130 is removed. This removal may comprise the step of moving the side wall 130 radially outward relative to the carrier 110 to create a radial offset between plates 120 and the side wall 130. The carrier 110 with the plurality of plates 120 is successively actuated to rotate. Due to the centrifugal force resulting therefrom, any residue present within the intermediate spaces between each of the plates 120 will be outwardly propelled and thereby removed from the separator 100. Moreover, due to the centrifugal forces acting on the plates 120, they may stretch and the initially curved shape may therefore become more straight. This also results in an increased circumferential distance between adjacent plates 120, which further facilitates any residue to be removed from within the intermediate spaces between each of the plates 120. A splash screen (not shown) may be placed around the separator 100 during this cleaning operation to catch residue ejected from the plurality of plates 120.

FIG. 2 shows a cross-sectional top-down view of in particular a portion of the plurality of plates 120 of the separator 100 shown in FIG. 1. As can be clearly discerned from this figure, each individual plate 121 among the plurality of plates 120 extends from the carrier 110 to abut an inner surface of the side wall 130.

Each plate 121 may be connected to the carrier 110 by means of a coupler 115. A respective coupler 115 may be provided for each plate 121 among the plurality of plates 120. Alternatively, two plates 121 may be connected to the carrier 110 by means of a single common coupler 155. In these embodiments, these two plates 121 may be arranged on opposing faces of said coupler 155. The coupler 115 may comprise a pivot to connect each of the plurality of plates 120 to the carrier 110 in a pivoting manner. Such embodiments of the separator 100 are particularly advantageous when the separator 100 is to be cleaned as described here above. After removal of the side wall 130, each of the plurality of plates 120 may pivot outward to thereby increase the intermediate space between neighbouring plates 121, making it easier for any debris or residue to become dislodged and removed from these intermediate spaces during a cleaning process of the separator 100 as described here above.

A plurality of supports 122 is provided on a respective concave surface of each plate 121. Each of the plurality of supports 122 is embodied as a protrusion 122 transversely extending from said surface and in a circumferential direction relative to the axial axis of the carrier 110. When each of the plurality of plates 120 is arranged around the carrier 110, each support 122 abuts an adjacent (neighbouring) plate 121. As such, the support 122 on each respective plate 121 provides circumferential support for during operation of the separator 100. In particular, the supports 122 maintain an intermediate distance between two consecutive plates 121 over a substantial portion of their lengths by preventing flexing or bending of the plates 121.

Consequently, the separator 100 of the embodiment of FIG. 2 may operate at higher rotation speeds than prior-art separators, be constructed at a scale larger than that of prior-art separators, or may be constructed using materials that are lighter and/or easier process than known separators. Exemplary materials from which in particular the plates 121 may be constructed include polymers and glass and carbon fiber materials.

At a distal end of each plate 121, a reinforcement 127 is provided on a surface opposite the surface of each plate 121 on which the supports 122 are provided. The reinforcements 127 contribute to an overall increase in rigidity and/or stiffness of each plate 121, in particular at the aforementioned distal end of each plate 121 near which they are placed, and may comprise reinforcement ribs.

In FIG. 2, each one of the plates 121 may be identical to one another with respect to their size, curvature and arrangement and number of the supports 122 on their respective surfaces. The supports 122 therefore collectively form concentric arrays of supports 122, in which the supports are arranged one behind the other in a circumferential direction of the plurality of plates 120. Seven of such concentric arrays are visible in FIG. 2, among which one is indicated by a dashed encirclement and indicated by the reference sign 129. Each concentric array of supports can be considered as a “force path” through which the forces acting upon the plates as a result of the centrifugal action are transmitted and absorbed. These forces and torques resulting therefrom will be elucidated further with reference to FIG. 3.

FIG. 3 shows a configuration of the plurality of plates 120 that is simplified relative to the configuration of FIG. 2 in that only a single support 122a, 122b is provided on each plate 121a, 121b, 121c; further supports 122 having been omitted for illustrative purposes. The plurality of plates 120 in FIG. 3 thus only comprises a single concentric array of supports 122.

It is emphasised here that the configurations of FIG. 1 and FIG. 2 with respect to the number of supports 122 provided on each plate 121 is merely exemplary in nature. An arbitrary number of supports 122 may be provided on each plate 121 at respective radial distances relative to the carrier 110. The skilled person may select the number of supports 122 provided on each plate 121 in consideration of other design parameters of the separator 100 without departing from the scope of the present disclosure.

FIG. 3 moreover depicts a centrifugal force F_{c} acting on a respective support 122a of a first plate 121a among the plurality of plates 120. This centrifugal force F_{c} results from a rotary motion of the carrier 110 and the plurality of plates 120 during operation of the separator 100, and induces mechanical stress on the first plate 121a.

As indicated by the vector arrows in FIG. 3, this centrifugal force F_{c} can be decomposed into a tangential force component F_{T} and a perpendicular force component F_{P}. The perpendicular force component F_{P} is directed substantially perpendicular to the tangential force component F_{T}, and moreover directed perpendicular the surface of plate 121a on the location at which the support 122b is disposed.

As already elucidated above with reference to FIG. 2, in FIG. 3 the first plate 121a is supported on a respective support 122b of a neighbouring second plate 121b to maintain the intermediate space between the first plate 122a and the second plate 122b. As can moreover be discerned from FIG. 3, a centerline of the support 122a is offset by a distance L from a centerline of the support 122b of the second plate 121b when viewed in a direction perpendicular to the surfaces of the first plate 121a and the second plate 121b. As such, the decomposed perpendicular force component F_{P} acting on support 122a of the first plate 121a is applied at distance L to its fulcrum, which is the support 122b of the neighboring plate 121b. Consequently, there is generated a torque defined as τ=L×F_{P} acting on the first plate 121a, which induces mechanical stress on this first plate 121a.

The distance L is the line of action at which perpendicular force component F_{P} is applied. Likewise, the support 122b of the second plate 121b among the plurality of plates 120 is affected by a centrifugal force, which similarly may be decomposed into a tangential force component F_{T} and a perpendicular force component F_{P}. The second plate 121b is supported by a further support 122c of a neighbouring third plate 121c, which again acts as fulcrum with respect to the perpendicular force component F_{P} centrifugal force acting on the support 122b of the second plate second plate 121b. As such, there exists a further torque acting on the second plate 121b, which is amplified due to the load of the first plate 121a and likewise induces mechanical stress on this second plate 121b. The same applies for each of the plurality of plates 120.

While the concentrically arranged supports 122 in the embodiments of FIG. 1 and FIG. 2 absorb a significant amount of the generated forces and generally maintain the intermediate distances between the each of the plurality of plates 120, the here above described generated torques do become problematic under certain conditions. Because these generated torques increase when the rotation speed of the separator 100 is increased, they may potentially result in damage to the plates 121 when the separator 100 operates at a relatively high rotational speed. Similarly, when each plate 121 is constructed of a lighter, more flexible material, or when the separator 100 including the plates 121 comprises increased physical dimensions, these generated torques may result in a (permanent) deformation of one or more of the plates 121.

To account for this limitation of the separator 100 according to the embodiments of FIG. 2 and FIG. 3, embodiments of the separator 100 according to the present invention comprise arrangements of the supports 122 different from those depicted in FIG. 2 and FIG. 3 in that they are non-concentric. FIG. 4, FIG. 5 and FIG. 6 depict an exemplary configuration of a plurality of plates 121 and supports 122 through which this is achieved.

FIG. 4 depicts a plate of a first type 123 and a plate of a second type 125 among further plates that have been omitted from the drawing for explanatory purposes. The plate of the first type 123 comprises one or more supports 124 on its concave surface and the plate of the second type 125 comprises one or more supports 126 on its concave surface. Each of the at least one supports 124 of the plate of the first type 123 may be associated with a corresponding support 126 of the plate of the second type 125.

The plate of the first type 123 plate of a second type 125 may be substantially identical to one another with respect to their size, their curvature in embodiments wherein said plates 123, 125 are curved, and the materials from which they are constructed. In FIG. 4, the plate of the first type 123 and the plate of the second type 125 differ from one another at least with respect to the arrangement of their respective supports 124, 126.

As can be discerned from FIG. 4, the plate of the first type 123 and the plate of the second type 125 each comprise seven supports 124, 126 on their respective surfaces. A first one of the supports 124 of the plate of the first type 123 closest to the carrier 110, and a first one of the supports 126 of the plate of the second type 125 closest to the carrier 110, are arranged to be approximately lined up one behind the other in at least part of the circumferential direction relative to the axial axis of the carrier 100, and may thus be considered associated with one another. The same is true for each pair of the respective second to seventh supports 124, 126 of the plate of the first type 123 and the plate of the second type 125.

The plate of the first type 123 has its at least one support 124 (for example, the aforementioned first support 124 closest to the carrier 100) arranged at a first radial distance relative to the carrier 110; whereas the plate of the second type 125 has its associated at least one support 126 (for example, the aforementioned first support 126 closest to the carrier 100) arranged at a second radial distance relative to the carrier 110, which is different from the aforementioned first radial distance. The consecutive second to seventh associated supports 124, 126 of, respectively, the plate of the first type 123 and the plate of the second type 125 likewise differ from one another with respect to their radial distance relative to the carrier 110.

The plate of the first type 123 and the plate of the second type 125 may be considered to constitute a plate pair. Both the first type 123 and the plate of the second type 125 may moreover be connected through a common coupler 115, which is preferably pivotable.

In FIG. 5, further plates of the first type 123 and plates of the second type 125 among the plurality of plates 120 are depicted. The plates of the first type 123 and the plates of the second type 125 are arranged alternately around a perimeter of the rotatable carrier 110.

As can be discerned from FIG. 5, the associated respective supports 124 of the plates of the first type 123 and the supports 126 of the plates of the second type 125 are arranged one behind the other in array-like formations similar to the embodiments of FIG. 2 and FIG. 3. In FIG. 5, the depicted parts of two of these array-like formations of consecutive supports 124, 126 are indicated by dashed encirclements. However, due to the plates of the first type 123 and the plates of the second type 125 each comprising associated supports 124, 126 that differ from one another with respect to their radial distance relative to the carrier 110, these array-like formations of supports 124, 126 are non-concentric with the (axial axis of) the carrier 110. In particular the at least one least one array of supports 124, 126 comprises a spiral-like shape, which is non-concentric with the axial axis of the carrier 110 and extends outwards. The advantages of such an arrangement of supports 124, 126 will be elucidated further here below with reference to FIG. 6.

In FIG. 5, the supports 124 of the plates of the first type 123 are collectively concentrically arranged around the (axial axis of) the carrier 110. Similarly, the supports 126 of the plates of the second type 125 are collectively concentrically arranged around the (axial axis of) the carrier 110. The concentric arrangement of the supports 124 of the plates of the first type 123 comprises a radius different from a radius comprised by the concentric arrangement of the supports 126 of the plates of the second type 125. Because the first plates of the first type 123 and the plates of the second type 125 are alternately arranged around the carrier 110, this difference in radii of the concentric arrangements of supports 124 and supports 126 results in the non-concentric, array-like arrangement of consecutive supports 124, 126 depicted in FIG. 5.

FIG. 6 shows the configuration of the plurality of plates 120 of FIG. 5; with the plurality of plates 120 comprising the plates of the first type 123 and the plates of the second type 125 alternately arranged around the carrier 110.

As indicated by the vector arrows in FIG. 6, a centrifugal force F_{C} acts on a given support 124a comprised by a plate of the first type 123 during operation of the separator 100. Similar to what is depicted in FIG. 3, this centrifugal force F_{C} may be decomposed into a tangential force component F_{T} and a perpendicular force component F_{P}. The perpendicular force component F_{P} is directed substantially perpendicular to the tangential force component F_{T} and moreover directed perpendicular to the location on the surface of the plate of the first type 123 at which the protrusion 124a is disposed.

The plate of the first type 123 is supported by a support 126b of an adjacent plate of the second type 125; the support 126b of the plate of the second type 125 being associated with the aforementioned support 124a of the plate of the first type 123. The support 126b of the plate of the second type 125 acts as a fulcrum for the perpendicular force component F_{P}.

As can moreover be discerned from FIG. 6, due to the non-concentric arrangement of the pluralities of supports 124a and 126b of the plates of the first type 123 and the second types of plates 125, a distance L′ between respective centerlines of supports 124a and 126b is decreased relative to the distance L of the embodiment of FIG. 3 and FIG. 4 comprising the concentric arrangement of consecutive supports 122. Consequently, a torque generated by perpendicular force component F_{P} having distance L′ as its line of action to support 126b as its fulcrum, is likewise decreased relative to the configuration depicted in FIG. 3. Consequently, the mechanical stresses acting on the plate of the first type 123 as a result of this generated torque are likewise mitigated.

Consecutive supports 124a, 126b of further plates 123, 125 likewise experience a torque that is decreased relative to the situation depicted in FIG. 3, due to respective lines of action (not indicated in FIG. 6) to their respective fulcrums—which each are a respective support 124a, 126b of a consecutive neighbouring plate 123, 125—being similarly decreased.

When one compares FIG. 3 with FIG. 6, it can moreover be discerned that the centrifugal force F_{C} in FIG. 3 comprises a direction that is substantially different from a circular direction in which the concentric array of supports comprising support 122b and 122c extends; whereas in FIG. 6, the direction of the centrifugal force F_{C} acting on support 124a to a much greater degree corresponds to, or overlaps with, the non-circular direction in which the non-concentric array of supports—comprising supports 124a and 126b—extends. The non-concentric arrangement of consecutive supports 124a, 126b in FIG. 6, which comprises a spiral-like shape relative to the axial axis of the carrier 110 and moreover extends outward relative to the (axial axis of) carrier 110, therefore more efficiently distributes and absorbs the centrifugal force Fc, which like the non-concentric array of consecutive supports 124a, 126 is directed substantially outward relative the (axial axis of) carrier 110.

It is for the above reasons that the embodiments of the present invention according to FIG. 4 to FIG. 6 are yet further improved with respect to their capability of withstanding generated forces or torques during operation of the separator 100, relative to the embodiments according to FIG. 2 and FIG. 3. This further improved capability of the separator 100 according to the embodiments FIG. 4 to FIG. 6 makes it possible to operate the separator 100 at higher rotation speeds, which in turn results in a higher centrifugal force acting on any particulars of a component suspended in a fluid from which said component is to be separated, thereby resulting in a further increased separation efficiency.

Moreover, the further improved capability of the separator 100 to withstand generated forces during operation makes it possible to construct the separator 100 using alternative materials other than more commonly applied materials such as (stainless) steel. In particular lighter materials, which typically exhibit a greater degree of flexibility and/or brittleness, such as polymers or materials comprising carbon or glass fibers, may be used without risk of failure even at higher rotation speeds of the separator 100.

Lastly, the further improved capability of the separator 100 to withstand generated forces during operation makes it possible to construct the separator 100 at a larger scale with increased physical dimensions. At such a larger scale, in particular the plates 120 are more inclined to flex and/or deform during operation of the separator 100 due to comprising a relatively decreased stiffness on account of their increased size. Because the forces and torques generated during operation of the separator 100 are better absorbed and/or decreased due to the arrangement of the supports 122 according to the general principles of the present invention, any flexing of the plates 120 during operation is at least diminished or even prevented entirely.

The separator 100 according to any one of the herein disclosed embodiments may be used in a method for separating one of more components from a fluid.

While the present invention has thus far been disclosed in the context of a separator, the disclosure is not limited thereto. There is moreover provided a plate assembly comprising a plurality of plates in accordance with any one of the here above described embodiments. Such a plate assembly may be installed in an existing (prior-art) separator, which is then retrofitted to thereby achieve the various advantages of the present invention as described here above.

It is emphasised here that the skilled person may make modifications to the embodiments of the present invention as disclosed herein without departing from the fundamental principles of the present invention as defined in at least the appended claims. For example, while the depicted embodiments comprise plates that are curved, straight (flat) plates may alternatively be used. Likewise, the plates may moreover exhibit a curvature in their length-wise direction parallel to the direction of the axial axis of the carrier, so that they exhibit a spiral-like shape. A further example of a modification that the skilled person may make is to place the supports of respective plates on their convex surfaces as opposed to on their concave surfaces as in the embodiments depicted in the figures.

In addition, other types of plates in addition the here above described plates of the first type 123 and plates of the second type 125 may be selected by the skilled person. As elucidated with reference to FIG. 4 to FIG. 6, the advantages obtained with the embodiments of the separator 100 according to these figures result from the further improved placement of the respective supports of consecutive plates, which are arranged to form a non-concentric arrangement extending outward. At least two different types of plates, being the plates of the first type 123 and plates of the second type 125, which differ from one another at least with respect to the arrangement of their respective supports, was found to be required to establish this advantageous arrangement of consecutive supports. Nevertheless, it is anticipated that similarly advantageous non-concentric arrangements of consecutive supports may be realised by utilising a hypothetical plate of a third type (not depicted), which differs from the aforementioned plates of the first type 123 and plates of the second type 125 at least with respect to the arrangement of the supports on its surface.

1. A plate type rotational separator, comprising:
a carrier that is rotatable around an axial axis thereof; and
a plurality of plates extending in an axial direction of, and in a radial outward direction relative to, the axial axis of the carrier,
wherein each of the plurality of plates comprises at least one support extending transverse to a surface of the plate and in a circumferential direction relative to the axial axis of the carrier, to thereby provide circumferential support for said plate when the support of said plate is supported on an adjacent plate of the plurality of plates during rotation of the carrier,
wherein the plurality of plates comprises at least plates of a first type and plates of a second type, and
wherein the plates of the first type have their respective at least one support arranged at a first radial distance relative to the carrier and the plates of the second type have their respective at least one support arranged at a second radial distance relative to the carrier, said second radial distance being different from the first radial distance.

2. (canceled)

3. The separator according to claim 1, wherein the plates of the first type and the plates of the second type are arranged alternately around a perimeter of the rotatable carrier.

4. The separator according to claim 1, wherein the plurality of plates comprises a plurality of plate pairs, each plate pair comprising one plate of the first type and one plate of the second type.

5. The separator according to claim 1, wherein the plate of the first type and the plate of the second type of each plate pair are connected to the rotatable carrier through a common coupler.

6. The separator according to claim 1, wherein the supports of the plates of the first type are concentrically arranged around the central axis of the carrier.

7. The separator according to claim 1, wherein the supports of the plates of the second type are concentrically arranged around the central axis of the carrier.

8. The separator according to claim 6, wherein the concentric arrangement of the supports of the plates of the first type comprises a radius which is different from a radius comprised by the concentric arrangement of the supports of the plates of the second type.

9. The separator according to claim 1, wherein the at least one support of the plate of the first type and the at least one support of the plate of the second type are arranged to be approximately lined up one behind the other in at least part of the circumferential direction relative to the axial axis of the carrier.

10. The separator according to claim 9, wherein the supports of the plates of the first type and the supports of the plates of the second type are disposed one behind the other to form at least one array of supports non-concentric with the rotatable carrier.

11. The separator according to claim 10, wherein the at least one array of supports at least partially extends outward relative to the rotatable carrier or comprises a spiral-like shape non-concentric with the axial axis of the carrier.

12. The separator according to claim 1, wherein the plates are curved.

13. The separator according to claim 12, wherein the surface of each plate at which its respective at least one support is disposed is a concave surface.

14. The separator according to claim 1, wherein at least one of the plates comprise a material from group comprising polymers, carbon fiber and glass fiber.

15. The separator according to claim 1, wherein the plates are pivotally connected to the carrier to allow the plates to pivot relative to the carrier.

16. (canceled)

17. A method for separating one of more components from a fluid, comprising usage of a plate type rotational separator according to claim 1.

18. A plate assembly installable in a plate type rotational separator, the plate assembly comprising:
a plurality of plates configured to extend in an axial direction of, and in a radial outward direction relative to, an axial axis of a carrier when installed in the plate type rotational separator;
wherein each of the plurality of plates comprises at least one support extending transverse to a surface of the plate and in a circumferential direction relative to the axial axis of the carrier, to thereby provide circumferential support for said plate when the support of said plate is supported on an adjacent plate of the plurality of plates during rotation of the carrier, and
wherein the plurality of plates comprises at least plates of a first type and plates of a second type, wherein the plates of the first type have their respective at least one support arranged at a first radial distance relative to the carrier and the plates of the second type have their respective at least one support arranged at a second radial distance relative to the carrier, said second radial distance being different from the first radial distance.
